(19) United States
(12) Patent Application Publication
(10) Pub. No.: US 2010/0328164 A1
(43) Pub. Date: Dec. 30, 2010

(54) SWITCHED ANTENNA WITH AN ULTRA WIDEBAND FEED ELEMENT

(76) Inventor: Minh-Chau Huynh, Morrisville, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(21) Appl. No.: 12/494,513

(22) Filed: Jun. 30, 2009

(51) Int. Cl. H01Q 9/04; H01Q 1/24

(52) U.S. Cl. 343/702; 343/700 MS

(57) ABSTRACT

An antenna that includes an ultra wideband (UWB) feed element, a parasitic conductive element, and a radio frequency (RF) switch. The UWB feed element is capable of radiating a first frequency band. The parasitic conductive element is connected to an electrical ground and capable of radiating a second frequency band. The parasitic conductive element has no electrical contact with the UWB feed element. The RF switch is connected between the parasitic conductive element and the electrical ground and configured to vary an electrical current path between the parasitic conductive element and the electrical ground. The varying of the electrical current path changes a resonant frequency of the second frequency band of the antenna.

### BACKGROUND OF THE INVENTION

The present invention is related to a switched antenna, and more specifically to a switched antenna with an ultra wideband feed element.

Antennas are used in many devices to transmit and receive signals. These signals may be radio frequency (RF) signals or other types of signals. Many antenna have a particular frequency bandwidth coverage that defines a range of frequencies that the antenna is configured to transmit and/or receive. However, there are cases where one may desire an antenna with the ability to switch between different frequency bands.

Many cell phones have antenna that may operate in one frequency band. However, some other cell phones are designed to operate in different frequency bands. This is useful when a person takes a cell phone to different parts of the world since different countries use different frequency bands for cell phone transmissions. For example, cellular frequency bands commonly used in the U.S. are the 850 MHz band for global system for mobile communication (GSM) transmissions and the 1900 MHz band for personal communications service (PCS) transmissions. These bands define two bandwidths of frequencies used for cell phone transmissions. For example, the 850-MHz band are defined a frequency range between 824 MHz and 894 MHz. The 1900-MHz band are defined a frequency range between 1850 MHz and 1990 MHz. In contrast, in Europe, two different bands are used, a 900 MHz frequency band for GSM transmissions and an 1800 MHz frequency band for digital cellular system (DCS) transmissions.

FIG. 1 shows a table of current frequency bands. The table shows transmit and receive frequencies for GSM 850, 900, 1800 and 1900 frequency bands as well as Wideband Code Division Multiple Access (WCDMA) frequency bands I- through VIII. The U.S. uses GSM 850 and 1900 frequency bands and WCDMA frequency bands II, IV and V. Other countries such as those in Europe or Asia use GSM 900 and 1800 frequency bands and WCDMA frequency bands I and VIII. As can be seen, the 3G WCDMA bands overlap the GSM bands in the respective countries. For example, in the U.S., the operators use GSM 850/1900 bands and WCDMA band II and V. If we look at the frequency coverage for each band between the GSM and WCDMA bands, GSM 850-MHz band frequency range overlaps WCDMA Band II. Similarly, the 1900-MHz GSM band frequency range overlaps that of the WCDMA Band II. So if an antenna could cover the GSM bands, it could cover the WCDMA bands.

However, as the size of wireless devices shrink, the size of antennas designed to fit inside these devices has to shrink also. According to the fundamental limit theory on antenna size, shrinking the size of an antenna reduces its frequency bandwidth. This is the challenge that antenna engineers are facing in today's wireless devices that are becoming smaller and smaller, yet needing to operate in more and more frequency bands.

### BRIEF SUMMARY OF THE INVENTION

According to one aspect of the present invention, an antenna includes an ultra wideband (UWB) feed element, the UWB feed element being capable of radiating a first frequency band, a parasitic conductive element, the parasitic conductive element being connected to an electrical ground and capable of radiating a second frequency band, the parasitic conductive element having no electrical contact with the UWB feed element, and a radio frequency (RF) switch, the RF switch being connected between the parasitic conductive element and the electrical ground and configured to vary an electrical current path between the parasitic conductive element and the electrical ground, the varying of the electrical current path changing a resonant frequency of the second frequency band of the antenna.

According to an aspect of embodiments of the present invention, when the RF switch is in an open position the second frequency band of the antenna covers a first resonant frequency band and when the RF switch is in a closed position the second frequency band of the antenna covers a second resonant frequency band. According to an aspect of embodiments of the present invention, when the RF switch is in an open position the first resonant frequency band of the antenna comprises a 900 MHz band and when the RF switch is in a closed position the second resonant frequency band of the antenna comprises a 850 MHz band.

According to an aspect of embodiments of the present invention, the first frequency band radiated by the UWB feed element is minimally affected by the changing of the resonant frequency of the second frequency band of the antenna. According to an aspect of embodiments of the present invention is included a second RF switch wherein when the second RF switch is in a closed position the second frequency band of the antenna covers a third resonant frequency band.

According to an aspect of embodiments of the present invention is included at least one third RF switch wherein when the at least one third RF switch is in a closed position the second frequency band of the antenna covers at least one fourth resonant frequency band. According to an aspect of embodiments of the present invention, the first frequency band comprises at least one of a 1800 MHz band and a 1900 MHz band.

According to an aspect of embodiments of the present invention, a resonant frequency of the first frequency band and a resonant frequency of the second frequency band are increased by decreasing a size of the antenna. According to an aspect of embodiments of the present invention, a resonant frequency of the first frequency band and a resonant frequency of the second frequency band are decreased by increasing a size of the antenna.

According to another aspect of the present invention, a mobile wireless device includes an input device, a processor, and an antenna, the antenna including an ultra wideband (UWB) feed element, the UWB feed element being capable of radiating a first frequency band, a parasitic conductive element, the parasitic conductive element being connected to an electrical ground and capable of radiating a second frequency band, the parasitic conductive element having no electrical contact with the UWB feed element, and a radio frequency (RF) switch, the RF switch being connected between the parasitic conductive element and the electrical ground and configured to vary an electrical current path between the parasitic conductive element and the electrical ground, the varying of the electrical current path changing a resonant frequency of the second frequency band of the antenna, wherein the mobile device is capable of communication with multiple networks that use different frequency bands.

According to an aspect of embodiments of the present invention, the mobile device comprises a mobile phone. According to an aspect of embodiments of the present invention, the multiple networks comprise cellular networks. According to an aspect of embodiments of the present invention, when the RF switch is in an open position the second frequency band of the antenna covers a first resonant frequency band and when the RF switch is in a closed position the resonant frequency band of the antenna covers a second resonant frequency band.

According to an aspect of embodiments of the present invention, when the RF switch is in an open position the first resonant frequency band of the antenna comprises a 900 MHz band and when the RF switch is in a closed position the second resonant frequency band of the antenna comprises a 850 MHz band. According to an aspect of embodiments of the present invention, the first frequency band radiated by the UWB feed element is minimally affected by the changing of the resonant frequency of the second frequency band of the antenna.

According to an aspect of embodiments of the present invention is included a second RF switch wherein when the second RF switch is in a closed position the second frequency band of the antenna covers a third resonant frequency band. According to an aspect of embodiments of the present invention is included at least one third RF switch wherein when the at least one third RF switch is in a closed position the second frequency band of the antenna covers at least one fourth resonant frequency band. According to an aspect of embodiments of the present invention, the first frequency band comprises at least one of a 1800 MHz band and a 1900 MHz band.

According to an aspect of embodiments of the present invention, a resonant frequency of the first frequency band and a resonant frequency of the second frequency band may be increased by decreasing a size of the antenna. According to an aspect of embodiments of the present invention, a resonant frequency of the first frequency band and a resonant frequency of the second frequency band may be decreased by increasing a size of the antenna.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 shows a table of current frequency bands.

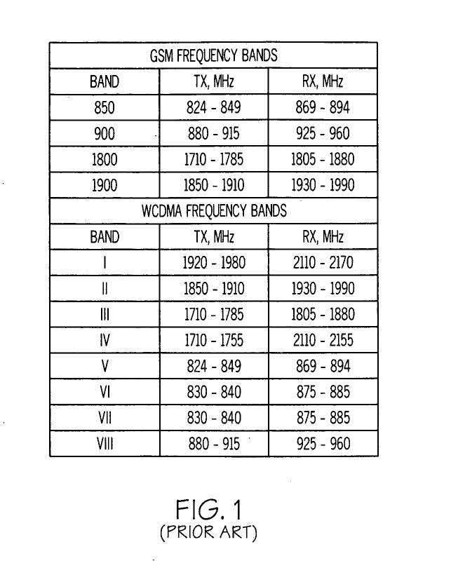

FIG. 2 is a diagram of an antenna according to an exemplary embodiment of the present invention;

FIG. 3 is a diagram of an antenna according to another exemplary embodiment of the present invention;

FIG. 4 is a diagram of an antenna according to a still further exemplary embodiment of the present invention;

FIG. 5 is a diagram of a mobile device incorporating an antenna according to an exemplary embodiment of the present invention;

FIG. 6 is a diagram of an antenna with physical dimensions according to an exemplary embodiment of the present invention;

FIG. 7 is a graph plotting frequency response for a parasitic conductive element of an antenna according to an exemplary embodiment of the present invention; and

FIG. 8 is a graph plotting frequency response for a UWB feed element of an antenna according to an exemplary embodiment of the present invention

### DETAILED DESCRIPTION OF THE INVENTION

Embodiments according to the present invention provide an antenna that includes an ultra wide band (UWB) feed element, a parasitic conductive element, and a RF switch where the UWB feed element provides a first frequency band coverage (e.g., high) for the antenna and the parasitic conductive element provides a second frequency band coverage (e.g., low) and the switch allows switching between different first frequency band and the second frequency band combinations. Embodiments according to the present invention allow a size of an antenna to be reduced from known sizes and occupy a small space, allowing switching between different frequency bands while having a minimal effect on a high frequency band. The spacing between the parasitic conductive element and the UWB feed element, and a length of the parasitic conductive element may each determine a resonant frequency of the second frequency band capable of being radiated by the parasitic conductive element. A size of the UWB feed element may determine a resonant frequency of the first frequency band capable of being radiated by the UWB feed element. The larger in size the UWB gets, the lower the resonant frequency of the first frequency band.

Embodiments according to the present invention provide switching between sets of first/second (or high/low frequency) bands while still maintaining an acceptable −6 decibels (dB) return loss or better (i.e., lower). The parasitic conductive element may be connected to an electrical ground. The parasitic conductive element may have no electrical connection with the UWB feed element. Further, the RF switch may be connected between the parasitic conductive element and the electrical ground when in a closed position, and provides an alternate electrical current path between the parasitic conductive element and the electrical ground. The alternate electrical current path changes a resonant frequency of the second frequency band of the parasitic conductive element and hence the antenna.

Therefore, according to embodiments of the present invention, when the RF switch is in an open position (and thus the parasitic conductive element has a first electrical path to ground), the second frequency band of the antenna may cover a first resonant frequency band and when the RF switch is in a closed position (and thus the parasitic conductive element has a second alternate electrical path to ground) the second frequency band of the antenna may cover a second resonant frequency band. For example, when the RF switch is in an open position, the first resonant frequency band of the antenna may be a 900 MHz band and when the RF switch is in a closed position, the second resonant frequency band of the antenna may be an 850 MHz band. The first frequency band radiated by the UWB feed element is minimally affected by the changing of the resonant frequency of the second frequency band of the antenna by the RF switch. The first frequency band of the UWB feed element may cover an 1800-MHz band and/or a 1900-MHz band. The resonant frequency of the first frequency band and a resonant frequency of the second frequency band may be increased by decreasing a size of the antenna (and hence the UWB feed element and the parasitic conductive element). Further, a resonant frequency of the first frequency band and a resonant frequency of the second frequency band may be decreased by increasing a size of the antenna. Switching the RF switch changes the resonant frequency band the parasitic conductive element is responsible of by providing a different path to electrical ground.

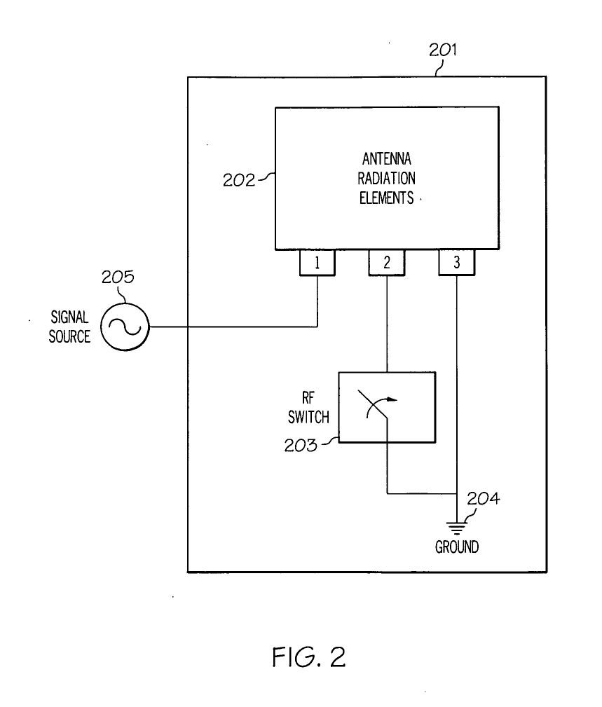

FIG. 2 shows a diagram of an antenna according to an exemplary embodiment of the present invention. The antenna 201 may include radiation elements 202, a RF switch 203, and an electrical ground 204. Although not shown, the antenna radiation element 202 may include a UWB feed element that radiates at a first frequency band and a parasitic conductive element that radiates at a second frequency band. The first frequency band may contain a range of higher frequencies than the second frequency band.

The parasitic conductive element of the antenna radiation elements 202 may be connected through a path 3 from the antenna radiation elements 202 to the electrical ground 204. The parasitic conductive element may also be connected through a second path 2 from the antenna radiation elements 202 to the RF switch 203. The UWB feed element may receive a signal to be radiated from a signal source 205 to the antenna radiation elements 202 through a third path 1. The RF switch 203 may provide an alternate path for the parasitic conductive element to the electrical ground 204 when the RF switch 203 is in a closed position. By switching the RF switch 203 between a closed and an open position, and therefore varying the electrical current path between the parasitic conductive element and the electrical ground 204, the resonant frequency of the second frequency band of the antenna may be changed. The first frequency band radiated by the UWB feed element may be minimally affected by the switching of the RF switch 203 and the changing of the resonant frequency of the second frequency band of the antenna.

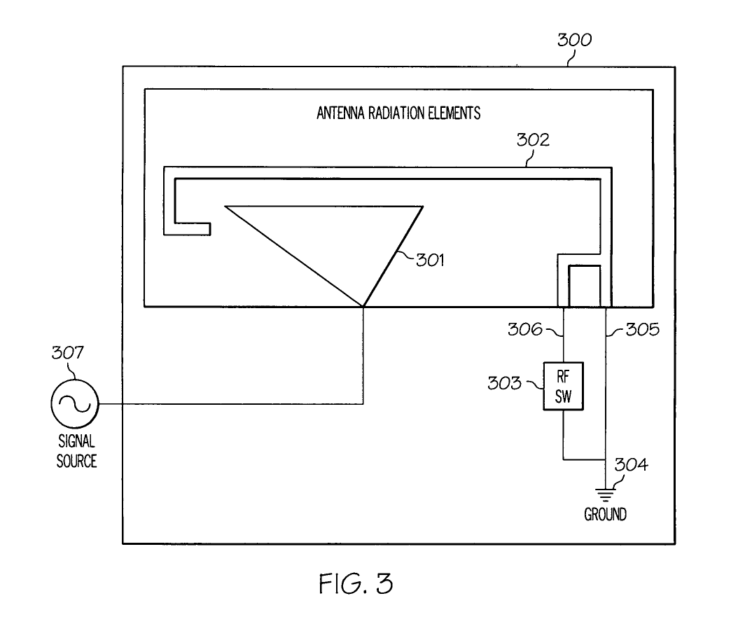

FIG. 3 shows a diagram of an antenna according to another exemplary embodiment of the present invention. The antenna 300 may include a UWB feed element 301, a parasitic conductive element 302, a RF switch 303, and an electrical ground 304. The parasitic conductive element 302 may be connected to the electrical ground 304 via a first connection path 305. Further, the parasitic conductive element 302 may be connected to the RF switch 303 through a second connection path 306. The RF switch 303, when in the closed position, may connect the parasitic conductive element 302 to the electrical ground 304 thereby providing an alternate path for the parasitic conductive element to the electrical ground 304. In contrast, when the RF switch 303 is in an open position, the parasitic conductive element 302 has the connection path 305 to the electrical ground 304. The length of the path to ground affects a resonant frequency of a frequency band radiated by the parasitic conductive element 302. Therefore, by changing the path of the parasitic conductive element 302 to the electrical ground 304, a resonant frequency of a frequency band radiated by the parasitic conductive element 302 can be changed.

The UWB feed element and the parasitic conductive element may be composed of a conductive material such as, for example, copper. The antenna 300 shows an illustration of the UWB feed element 301 that may consist of a piece of copper on an electronic circuit board as is well understood. Similarly, the parasitic conductive element may be conductive material 302 that is a part of an electronic circuit board as is well understood. The UWB feed element 301 may receive a signal for transmission from a signal source 307 external to the antenna 300.

The UWB feed element 301 may have a radiating response in a first frequency band. For example, the first frequency band may be a high frequency band covering, for example, 1.7-2.2 GHz. Capacitive feeding from the UWB feed element 301 to the parasitic conductive element 302 may create resonance in a second frequency band. The second frequency band may be a low frequency band such as in the 900 MHz region, for example. The RF switch 303 allows the variation of the current path to ground 304 for the parasitic conductive element 302 thereby allowing the varying of the second frequency band resonance without affecting the first frequency band significantly. For example, if the RF switch 303 is in an open position, the path to ground 304 for the parasitic conductive element 302 may create a resonance covering a 900 MHz frequency band. Further, if the RF switch 303 is in a closed position, the path ground 304 of the parasitic conductive element 302 may create a resonance frequency band covering a 850 MHz frequency band. Therefore, according to embodiments of the present invention, an RF switch 303 may be used to vary a resonance frequency band of an antenna 300. Further, the variance of the second frequency band by closing/opening the RF switch 303 has minimal effect on the first resonance frequency band radiated by the UWB feed element 301.

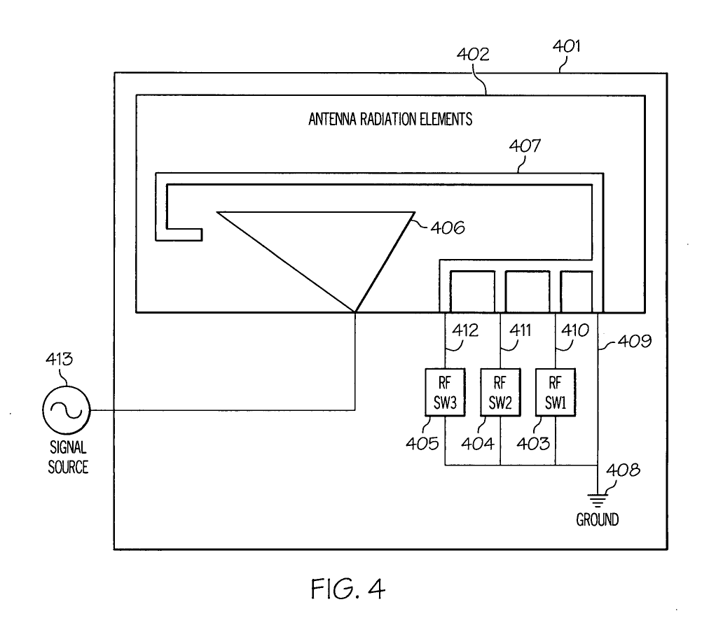

FIG. 4 shows a diagram of an antenna according to a still further exemplary embodiment of the present invention. The antenna 401 may include radiation elements 402, a first RF switch 403, a second RF switch 404, and a third RF switch 405. The antenna radiation elements 402 may include a UWB feed element 406 and a parasitic conductive element 407. The UWB feed element 406 may receive a signal from a signal source 413 external to the antenna 401. The parasitic conductive element 407 may be connected to an electrical ground 407 via a connection path 409. Further, the first RF switch 403 may provide a first alternate connection path 410 between the parasitic conductive element and 407 and the electrical ground 408. Further, the second RF switch 404 may provide a second alternate connection path 411 for the parasitic conductive element 407 to the electrical ground 408. The third RF switch 405 may similarly provide a third alternate connection path 412 between the parasitic conductive element 407 and the electrical ground 408. The four different connection paths 409, 410, 411, 412 are of different lengths. Therefore, when any one of the first RF switch 403, the second RF switch 404, or the third RF switch 405, are in a closed position, this allows the changing to one of a second resonant frequency band, a third resonant frequency band, or a fourth resonant frequency band that the parasitic conductive element 407 may be capable of radiating. Each of the RF switches 410, 411, 412 allows the changing of a frequency band radiated by the parasitic conductive element 407 from the one radiated when the parasitic conductive element 407 is connected to the electrical ground 408 via the connection path 409 without any switches. Thus in this exemplary embodiment, the parasitic conductive element 407 may switch between four different resonant frequency bands by using the first RF switch 403, the second RF switch 404, or the third RF switch 405. The present invention is not limited to merely three switches but may include fewer or more switches and still be within the scope of embodiments of the present invention.

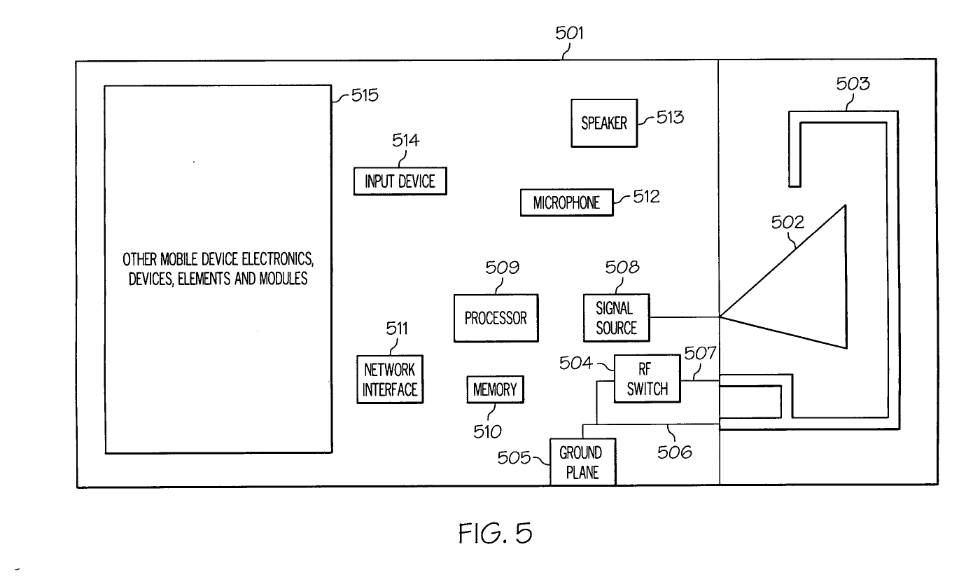

FIG. 5 shows a diagram of a mobile wireless device incorporating an antenna according to an exemplary embodiment of the present invention. The mobile device 501 may be any type of mobile device such as, for example, a cellular telephone, a personal digital assistant (PDA), a portable game system, a laptop computer, etc. The portable device 501 is illustrated as a circuit board including components and functional elements with only the traces for the antenna radiation elements shown. However, the components shown in the portable device 501 may be interconnected via circuit board traces and connections not shown as is well understood. The mobile device 501 may include a parasitic conductive element 503 and a UWB feed element 502 that may make up antenna radiation elements. According to embodiments of the present invention, the antenna radiation elements (UWB feed element 502 and parasitic conductive element 503) do not have to be located in one plane. The elements can be designed and located in a 3-dimensional space relative to each other. The mobile device 501 may also include one or more RF switches 504, an electrical ground plane 505, a signal source 508, a processor 509, a memory or storage device 510, a network interface 511, a microphone 512, a speaker 513, an input device 514, and other mobile device electronics, devices, elements, and modules 515. The network interface 511 may include devices and/or software for communicating with a cellular telephone network, the Internet, a private network, a home network, and/or any other type of network. The UWB feed element 502 may receive a signal from the signal source 408 for transmitting. The parasitic conductive element 503 may capacitively feed the UWB feed element 502 and may be connected to the electrical ground plane 505 via a connection path 506. The RF switch 504 may provide an alternate path for the parasitic conductive element 503 to the electrical ground plane 505 through a connection path 507 when the RF switch 504 is in a closed position.

The UWB feed element 502 may have a radiating response in a first frequency band. For example, the first frequency band may be a high frequency band covering, for example, 1.7-2.2 GHz. Capacitive feeding from the UWB feed element 502 to the parasitic conductive element 503 may create resonance in a second frequency band. The second frequency band may be a low frequency band having a potential to cover, for example, 824-960 MHz. The RF switch 504 allows the variation of the current path to ground 505 for the parasitic conductive element 503 thereby allowing the varying of the second frequency band resonance without affecting the first frequency band significantly. For example, if the RF switch 504 is in an open position, the path to ground 505 for the parasitic conductive element 503 may create a resonance covering a 900 MHz frequency band. Further, if the RF switch 504 is in a closed position, the path ground 505 of the parasitic conductive element 503 may create a resonance frequency band covering a 850 MHz frequency band. Therefore, according to embodiments of the present invention, an RF switch 504 may be used to vary a resonance frequency band of a mobile device 501 antenna. Further, the variance of the second frequency band by closing/opening the RF switch 504 has minimal effect on the first resonance frequency band radiated by the UWB feed element 502.

The mobile device 501 may have the ability for cellular telecommunications via the network interface 511 or other functionality in the mobile device 501 and thus may transmit and receive over different cellular communication frequencies. For example, the one or more RF switches 504 may provide the mobile device 501 the ability to switch between U.S. and European cellular frequency band defined by 850- and 1900-MHz bands (e.g., GSM transmissions U.S. operating bands) and 900- and 1800-MHz bands (e.g., European operating bands). These bands define operating frequency bands used for cell phone transmissions. The 850 MHz band may define a frequency range between 824 MHz and 894 MHz. The 900 MHz band may define a frequency range between 880 MHz and 960 MHz. The 1800-MHz band may define a frequency range between 1710 MHz and 1880 MHz. The 1900-MHz band may define a frequency range between 1850 MHz and 1990 MHz.

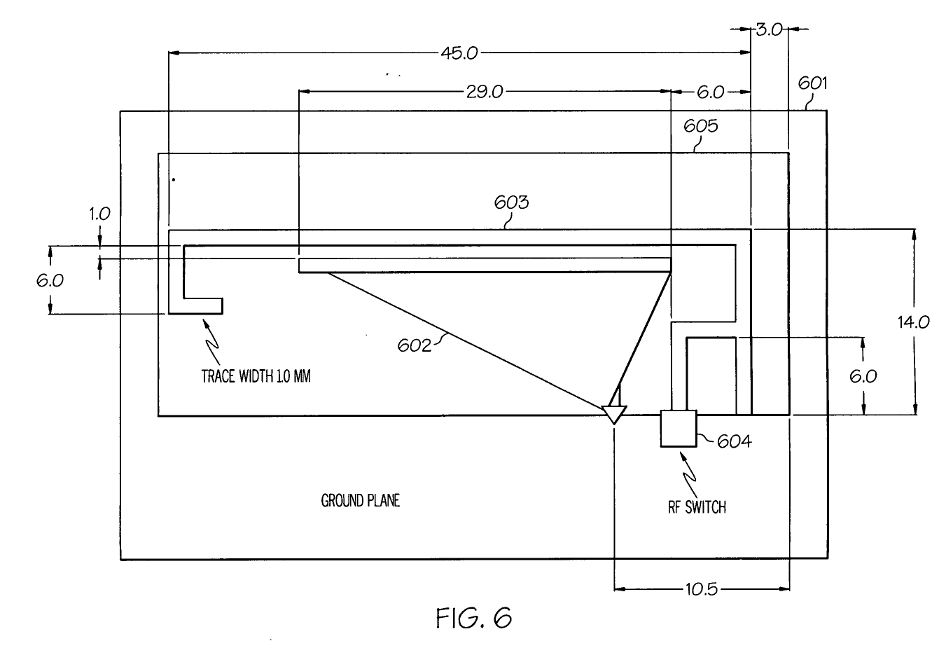

FIG. 6 shows a diagram of an antenna with physical dimensions according to an exemplary embodiment of the present invention. The antenna 601 may include a parasitic conductive element 603, a UWB feed element 602, and an RF switch 604. This exemplary embodiment shows several example detailed dimensions for the antenna 601 where all dimensions shown are in millimeters (mm). For example, a trace width of the parasitic conductive element 603 may be 1 mm wide. The parasitic conductive element 603 may be composed of a first portion that may be 6 mm in length, a second portion substantially perpendicular to the first portion that may be 6 mm in length, a third portion connected substantially perpendicular to the second portion that may be 45 mm in length and a fourth portion connected substantially perpendicular to the third portion that may be 14 mm in length. Further, a stub portion may connect from the RF switch 604 and be parallel to the fourth portion of the parasitic conductive element 603 at a length of 6 mm and also include another part perpendicular to the first part that connects to the fourth portion of the parasitic conductive element 603 that is 6 mm in length. The UWB feed element may be 29 mm wide at its widest end and may be a distance 6 mm from the fourth portion of the parasitic conductive element 603. The fourth portion of the parasitic conductive element 603 may be 3 mm from the end of a printed circuit board antenna section upon which it resides. The UWB feed element may be 12 mm in height and a top of the widest portion of the UWB feed element may be 1 mm from the second portion of the of the parasitic conductive element 603. The base of the UWB feed element 602 may be 10.5 mm from the end of the circuit board antenna section.

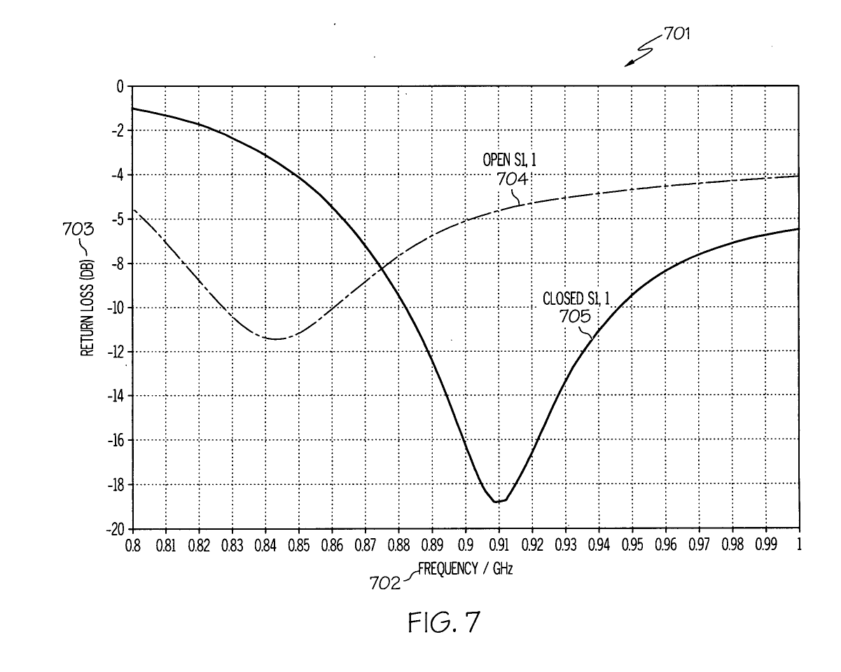

FIG. 7 shows a graph plotting frequency response for a parasitic conductive element of an antenna according to an exemplary embodiment of the present invention. The graph 701 plots frequency 702 on a horizontal axis versus return loss 703 in a vertical axis. The frequency in the horizontal axis 702 is in GHz and the return loss in the vertical axis 703 is in decibels (dB). The graph 701 shows two different frequency response curves. The first curve 704 represents an example resonant frequency band of a parasitic conductive element when an RF switch is in an open position. Further, the second plot 705 shows an example frequency band radiated by the parasitic conductive element when a RF switch is in the closed position. As can be seen from the graph 701, by opening or closing the RF switch, a resonant frequency band of the parasitic conductive element can be changed. In this exemplary embodiment, using the −6 dB return loss as a guide, the parasitic conductive element provides approximately a frequency band between 0.8 GHz and 0.9 GHz when in the RF switch is in open position as shown by the plot 704, and provides a resonant frequency band from approximately 0.86 GHz to 1 GHz when the RF switch is in the closed position as shown by the second plot 605.

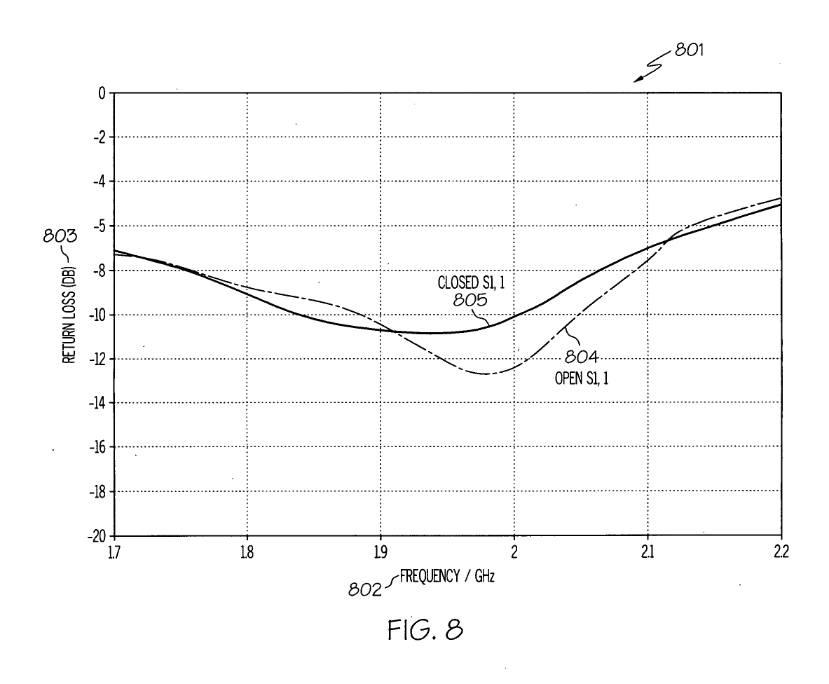

FIG. 8 shows a graph plotting frequency response for a UWB feed element of an antenna according to an exemplary embodiment of the present invention. The graph 801 plots frequency 802 on a horizontal axis versus return loss 803 in a vertical axis. The frequency in the horizontal axis 802 is in GHz and the return loss in the vertical axis 803 is in decibels (dB). The graph 801 shows two different frequency response curves. The first curve 804 represents an example resonant frequency band of a UWB feed element when an RF switch is in an open position. Further, the second plot 805 shows an example frequency band radiated by the UWB feed element when a RF switch is in the closed position. As can be seen from the graph 801, the resonant frequency band of the UWB feed element has only been minimally affected by switching the RF switch between an open position as shown by the first graph 804 and a closed position as shown by the graph 805. The resonant frequency band of the UWB feed element has minimal variance. Therefore, as illustrated, embodiments according to the present invention provide for a RF switch to vary a resonant frequency band of a parasitic conductive element portion of an antenna while having minimal affect on a resonant frequency band radiated by a UWB feed element portion of the antenna.

Embodiments according to the present invention provide advantages over current solutions. Instead of trying to design an antenna that has bandwidth large enough to cover all the operating bands, e.g., 850/900/1800/1900 MHz GSM bands, embodiments according to the present invention include an RF switch that overcomes this design challenge in small wireless devices. For example, instead of designing a quad-band antenna covering 850/900/1800/1900 MHz bands in a small wireless device, according to embodiments of the present invention, one can design a triple-band antenna (easier to design) used with an RF switch providing coverage of either 850/1800/1900 MHz bands (i.e., RF switch in closed state) or 900/1800/1900 MHz bands (i.e., RF switch in open state). If the wireless device is used in the United States, then the RF switch is in the closed state and the antenna system can cover the U.S. GSM operating bands (850- and 1900-MHz bands). If the wireless device is in Europe or Asia, then the RF switch in the open state allows the antenna system to cover the European or Asian GSM operating frequency bands (900- and 1800-MHz bands). Note this is valid for the 3G WCDMA operating bands.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. An antenna comprising:
an ultra wideband (UWB) feed element, the UWB feed element being capable of radiating a first frequency band;
a parasitic conductive element, the parasitic conductive element being connected to an electrical ground and capable of radiating a second frequency band, the parasitic conductive element having no electrical contact with the UWB feed element; and
a radio frequency (RF) switch, the RF switch being connected between the parasitic conductive element and the electrical ground and configured to vary an electrical current path between the parasitic conductive element and the electrical ground, the varying of the electrical current path changing a resonant frequency of the second frequency band of the antenna.

2. The antenna according to claim 1, wherein when the RF switch is in an open position the second frequency band of the antenna covers a first resonant frequency band and when the RF switch is in a closed position the second frequency band of the antenna covers a second resonant frequency band.

3. The antenna according to claim 2, wherein when the RF switch is in an open position the first resonant frequency band of the antenna comprises a 900 MHz band and when the RF switch is in a closed position the second resonant frequency band of the antenna comprises a 850 MHz band.

4. The antenna according to claim 1, wherein the first frequency band radiated by the UWB feed element is minimally affected by the changing of the resonant frequency of the second frequency band of the antenna.

5. The antenna according to claim 1, further comprising a second RF switch wherein when the second RF switch is in a closed position the second frequency band of the antenna covers a third resonant frequency band.

6. The antenna according to claim 5, further comprising at least one third RF switch wherein when the at least one third RF switch is in a closed position the second frequency band of the antenna covers at least one fourth resonant frequency band.

7. The antenna according to claim 1, wherein the first frequency band comprises at least one of a 1800 MHz band and a 1900 MHz band.

8. The antenna according to claim 1, wherein a resonant frequency of the first frequency band and a resonant frequency of the second frequency band are increased by decreasing a size of the antenna.

9. The antenna according to claim 1, wherein a resonant frequency of the first frequency band and a resonant frequency of the second frequency band are decreased by increasing a size of the antenna.

10. A mobile device comprising:
an input device;
a processor; and
an antenna, the antenna comprising:
an ultra wideband (UWB) feed element, the UWB feed element being capable of radiating a first frequency band;
a parasitic conductive element, the parasitic conductive element being connected to an electrical ground and capable of radiating a second frequency band, the parasitic conductive element having no electrical contact with the UWB feed element; and
a radio frequency (RF) switch, the RF switch being connected between the parasitic conductive element and the electrical ground and configured to vary an electrical current path between the parasitic conductive element and the electrical ground, the varying of the electrical current path changing a resonant frequency of the second frequency band of the antenna,
wherein the mobile device is capable of communication with multiple networks that use different frequency bands.

11. The mobile device according to claim 10, wherein the mobile device comprises a mobile phone.

12. The mobile device according to claim 11, wherein the multiple networks comprise cellular networks.

13. The mobile device according to claim 10, wherein when the RF switch is in an open position the second frequency band of the antenna covers a first resonant frequency band and when the RF switch is in a closed position the resonant frequency band of the antenna covers a second resonant frequency band.

14. The mobile device according to claim 11, wherein when the RF switch is in an open position the first resonant frequency band of the antenna comprises a 900 MHz band and when the RF switch is in a closed position the second resonant frequency band of the antenna comprises a 850 MHz band.

15. The mobile device according to claim 10, wherein the first frequency band radiated by the UWB feed element is minimally affected by the changing of the resonant frequency of the second frequency band of the antenna.

16. The mobile device according to claim 10, further comprising a second RF switch wherein when the second RF switch is in a closed position the second frequency band of the antenna covers a third resonant frequency band.

17. The mobile device according to claim 16, further comprising at least one third RF switch wherein when the at least one third RF switch is in a closed position the second frequency band of the antenna covers at least one fourth resonant frequency band.

18. The mobile device according to claim 10, wherein the first frequency band comprises at least one of a 1800 MHz band and a 1900 MHz band.

19. The mobile device according to claim 10, wherein a resonant frequency of the first frequency band and a resonant frequency of the second frequency band may be increased by decreasing a size of the antenna.

20. The mobile device according to claim 10, wherein a resonant frequency of the first frequency band and a resonant frequency of the second frequency band may be decreased by increasing a size of the antenna.
